(19) United States
(12) Patent Application Publication
(10) Pub. No.: US 2006/0162485 A1
(43) Pub. Date: Jul. 27, 2006

(54) Automotive steering wheel

(76) Inventors: Jeremy Leng, Newport Beach, CA (US); Matthew Hill, Irvine, CA (US); Kris Tomasson, Corona del Ma, CA (US); David Woodhouse, Newport Coast, CA (US)

Correspondence Address: BROOKS KUSHMAN P.C./FGTL, 1000 TOWN CENTER, 22ND FLOOR, SOUTHFIELD, MI, 48075-1238, US

(21) Appl. No.: 11/031,294

(22) Filed: Jan. 7, 2005

(51) Int. Cl. G05G 1/10

(52) U.S. Cl. 74/552

(57) ABSTRACT

The present invention discloses a steering wheel assembly having a hub, a spoke extending from the hub, and a wheel mounted to the spoke for controlling the steering operation of the vehicle. A contoured web is disclosed for facilitating an ergonomic gripping of the steering wheel and for providing comfort to the driver. The invention also discloses a plurality of vehicle operation controls mounted upon the steering wheel assembly for facilitating convenience to the driver while operating the vehicle.

### BACKGROUND OF THE INVENTION

1. Field of the Invention

The invention relates to automotive steering wheels, and more particularly, to automotive steering wheels having grip enhancing or convenience enhancing features.

2. Background Art

Automotive vehicles have often employed a steering wheel disposed within a passenger compartment, that is presented facing a seated driver. Steering wheels are typically mounted to a steering column such that manual rotation of the steering-wheel transmits rotation through the steering column to an input shaft of a steering gear assembly. Consequently, the steering gear assembly rotates a set of wheels of the vehicle.

Continuous driving requires a driver to maintain one or two hands upon the steering wheel during the course of travel. Prolonged travel can cause discomfort or cramping to a hand or wrist of the driver due to a lack of ergonomic grip support provided on the steering wheel.

A driver of an automotive vehicle is required to operate operational or ancillary features other than steering. Operations such as braking, throttle and clutch disengagement are often controlled by foot operated pedals. Cruise control settings are conventionally operated by levers or switches on a steering column, instrument panel or steering wheel assembly. The driver is often required to control features such as external lighting. In the occasion of inclement weather, the driver may be required to operate the wipers of the vehicle.

For listening pleasure while driving, the driver may manually control an audio device located in the vehicle.

Many of these ancillary features, which require manual control, are often provided on an instrument panel of the automotive vehicle. For enhancing convenience, the prior art has provided manual controls for cruise control and audio device control on the associated steering wheel assembly, often located on a steering wheel hub.

In the advent of improved passenger safety, the prior art has provided air bags within steering wheel assemblies.

In view of the foregoing, it is a goal of the present invention to enhance comfort and ergonomics to the driver. It is also a goal to enhance convenience to the driver.

### SUMMARY OF THE INVENTION

An aspect of the present invention is to provide a steering wheel assembly for an automotive vehicle having a hub connected to a steering column, a spoke extending from the hub, and a wheel mounted to the spoke. A contoured web extends inward from the wheel near an intersection of the spoke and the wheel. The web provides support to the hand of the driver.

A further aspect of the present invention is to provide a pair of collinear spokes, which bisect the wheel.

Another aspect of the present invention is to provide a steering wheel having a web extending from the wheel and engaging a spoke.

A further aspect of the present invention is to provide a web extending inward from a wheel, wherein the web declines inward to be contoured for the driver's grip.

Another aspect of the present invention is to provide a palm supporting web extending inward from a steering wheel, oriented beneath a spoke of the steering wheel when the steering wheel is aligned with a straight steering direction of the vehicle.

Yet another aspect of the present invention is to provide a cruise control switch on the steering wheel assembly.

A further aspect of the present invention is to provide an audio device control switch on the steering wheel assembly.

Another aspect of the present invention is to mold a web integrally with a grip portion of a steering wheel.

A further aspect of the present invention is to provide a web molded integrally with a distal end of a spoke of a steering wheel.

Yet another aspect of the present invention is to provide a web with a contoured surface that lies between an external surface of the steering wheel and the steering column.

Another aspect of the present invention is to provide a spoke that lies between a plane which includes an external surface of the steering wheel and the steering column.

An aspect of the present invention is to provide a steering wheel assembly having a hub with an outward extending spoke, a wheel mounted to the spoke, a turn signal switch provided on the hub, a headlight switch provided on the hub, a hazard signal switch provided on the hub, and a wiper switch provided on the hub.

A further aspect of the invention is to provide an air bag assembly within the hub.

In one embodiment, a steering wheel assembly is provided with a pair of collinear spokes extending from the hub, and a third spoke extending from the hub perpendicular to the collinear spokes.

A further aspect of the present invention is to provide a three spoke steering wheel assembly having a wiper switch provided on the third spoke.

Another aspect of the present invention is to provide a pair of spaced apart webs each extending radially inward from the wheel towards one of a plurality of spokes of the steering wheel assembly.

In one embodiment, a steering wheel assembly is provided with a hub, a cross member extending outward from opposed sides of the hub, a wheel mounted to the cross member, and a pair of webs each extending radially inward from the wheel and engaging the cross member. The web may have a decline relative to the wheel for supporting a palm of a hand of a passenger.

The above aspects and other aspects, objects, embodiments, features, benefits and advantages will be apparent from the accompanying figures and the description of the embodiments of the invention.

### BRIEF DESCRIPTION OF THE DRAWINGS

FIG. 1 is a perspective view of a steering wheel assembly in accordance with the present invention, illustrated in an automotive interior environment;

FIG. 2 is an enlarged perspective view of the steering wheel assembly of FIG. 1;

FIG. 3 is a partial section view taken across section line 3-3 in FIG. 2; and

FIG. 4 is a front side elevation view of an alternative steering wheel assembly in accordance with the teachings of the present invention.

### DETAILED DESCRIPTION OF EMBODIMENTS OF THE INVENTION

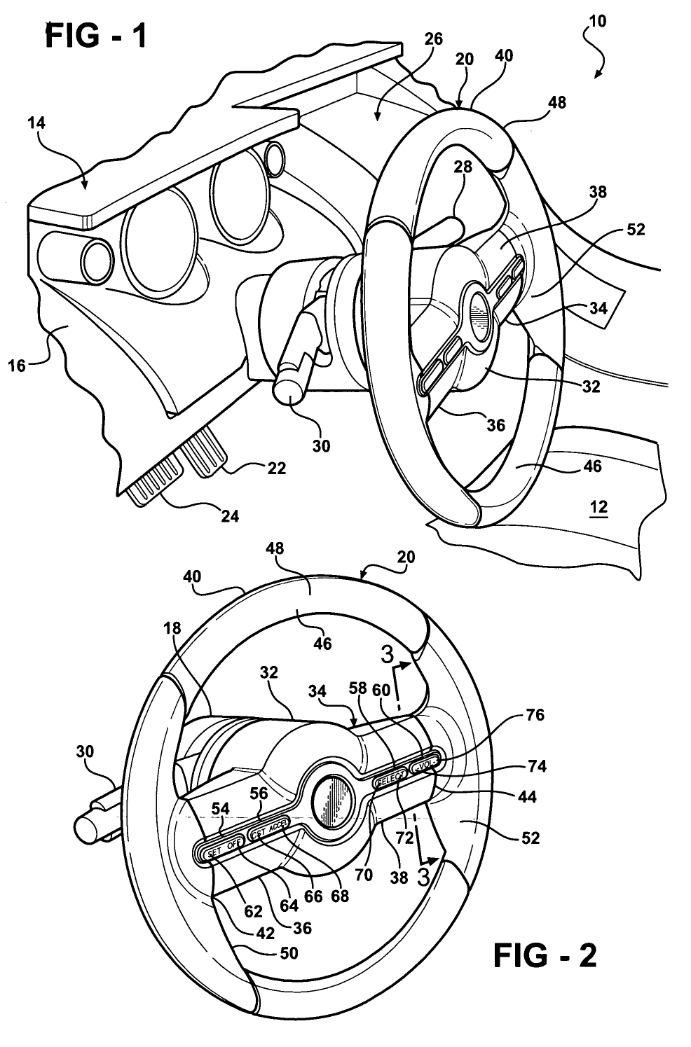

With reference to FIG. 1, an automotive environment, particularly an interior for a passenger vehicle for transporting a passenger therein, is illustrated and referenced generally by numeral 10. The automotive interior 10 includes a driver seat 12 for comfortably supporting a driver sitting thereon. A driver faces a dashboard 14 and an instrument panel 16 when seated. A steering column 18 extends from the instrument panel 16. A steering wheel assembly 20 is mounted on the steering column 18 generally facing the driver and proximate to and spaced above the seat 12.

A gas pedal 22 and a brake pedal 24 are provided beneath the instrument panel 16 proximate to floor level for operation by the driver's feet. A center console 26 is provided adjacent to the driver seat 12 and disposed between the driver seat 12 and another front passenger seat.

The driver operates the acceleration and deceleration of the vehicle by depressing the gas pedal 22 or brake pedal 24. The driver controls the steering operation by manual rotation of the steering wheel assembly 20. Other controls associated with the vehicle are provided on the center console 26. The controls provided on the console 26 are generally ancillary in nature and are not directed to the driving operation of the vehicle. For example, controls for an audio device are provided on the console 26.

Other operational controls of the vehicle are provided on the steering column 18. For example, a windshield wiper control lever 28 extends laterally from the steering column 18 so that the driver may control windshield wipers without having to reach far from the steering wheel assembly 20. The steering column 18 also includes a lamp control lever 30 extending laterally from the steering column 18 on an opposed side from the windshield wiper control lever 28. The lamp control lever 30 permits the driver to control headlight intensity and turn signal indication of lamps mounted to the vehicle's exterior.

Referring now to FIG. 2, the steering wheel assembly 20 and steering column 18 are illustrated enlarged for detail. The steering wheel assembly 20 includes a hub 32 mounted to the steering column 18. The hub 32 is connected for rotation with an input shaft of a steering gear assembly (not shown) for controlling rotation of front wheels of the vehicle. Thus, rotation of the hub 32 controls a steering direction of the vehicle.

A cross member 34 extends radial outward from the hub 32 on opposed distal sides thereof. The cross member 34 comprises a pair of collinear spokes 36, 38 oriented generally horizontal in a straight steering direction of the vehicle.

A wheel 40 is mounted to distal ends 42, 44 of the spokes 36, 38. The wheel 40 has a central cavity 46 formed therethrough providing an outward grip portion 48 that is sized to be gripped by the driver. The central cavity 46 is bisected by the spokes 36, 38. The grip portion 48 may be gripped by the driver for imparting rotation to the spokes 36, 38 and hub 32 thereby controlling the steering direction of the vehicle.

Often times during travel, a driver may grip the wheel 40 at relaxed positions, generally between three o'clock and four o'clock of a clock face with the right hand, and generally between eight o'clock and nine o'clock with the left hand. To ergonomically support the palm of a user's hand during these gripping locations, a pair of contoured webs 50, 52 are provided for supporting the driver's palms. Each web 50, 52 extends radially inward from the wheel 40 adjacent to an intersection of the wheel 40 and the corresponding spoke 36, 38. Additionally, each web 50, 52 may bridge across the included angle and engage the corresponding spoke 36, 38.

Each web 50, 52 has a curved slope that declines relative to the wheel 40 in an inward radial direction. This slope is contoured to match a common palm grip arrangement. When the spokes 36, 38 are arranged collinear and bisecting the wheel 40, the webs 50, 52 may be provided beneath the spokes 36, 38.

The webs 50, 52 may each be integrally molded with a distal end 42, 44 of the corresponding spoke 36, 38. The webs 50, 52 may also be molded integrally with a section of the grip portion 48.

For enhancing convenience to the driver, the steering wheel assembly 20 may be provided with control switches for operating the vehicle. As illustrated in FIG. 2, rocker switches 54, 56, 58, 60 may be provided across the spokes 36, 38. These rocker switches 54, 56, 58, 60 include switches for controlling a cruise control and an audio device of the vehicle.

The first rocker switch 54 provided on the left spoke 36 includes a cruise control set button 62 and a cruise control off button 64. The second rocker switch 56 includes a coast button 66 and an accelerate button 68. These rocker switches 54, 56 are in operable communication with an electronic control unit of the vehicle for permitting the user to set the cruise control, turn off the cruise control, set the cruise control in a coast mode, and accelerating the vehicle while raising the setting of the cruise control speed.

Rocker switches 58, 60 operate an ancillary function of the vehicle. Specifically, rocker switches 58, 60 provide redundant control to the audio device within the vehicle. This redundant control permits a passenger to control the audio device from the center console 26, or permits the driver to control the audio device from the steering wheel assembly 20. Rocker switches 58 and 60 are each in operable communication with the audio device. Rocker switch 58 includes a select-down button 70 and a select-up button 72 for changing a frequency or a track of an input audio media. Rocker switch 60 includes a volume-down button 74 and a volume-up button 76 for changing an amplitude of output volume from the audio device.

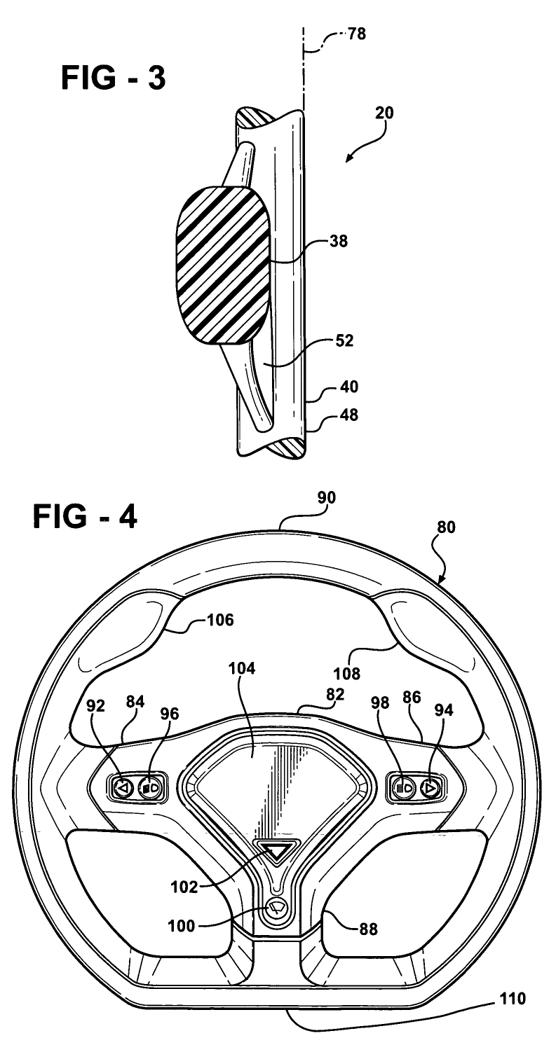

Referring now to FIG. 3, a portion of the steering wheel assembly 20 is illustrated in a partial fragmented section view taken along line 3-3 of FIG. 2. An external surface of the steering wheel 40 lies in a plane 78. The spoke 38 and the web 52 are oriented between the plane 78 and the steering column 18. This arrangement aligns the web 52 at an optimal recessed orientation so that the driver's palm engages the contoured web 52 when the driver rests his hand between the three o'clock and four o'clock positions about the steering wheel 40.

Referring now to FIG. 4, an alternative embodiment steering wheel assembly 80 is illustrated in accordance with the teachings of the present invention. The steering wheel assembly 80 includes a hub 82 mounted to a steering column 18. The steering wheel assembly 80 includes a pair of collinear spokes 84, 86 extending horizontally from the hub 82 when the steering wheel assembly 80 is oriented at a straight steering direction of the vehicle. A third spoke 88 extends from the hub 82, generally perpendicular to the first and second spokes 84, 86. A steering wheel 90 is mounted to distal ends of the first, second and third spokes 84, 86, 88 and is sized to be gripped by a driver. Similar to the prior embodiment, the driver rotates the wheel 90 to collectively rotate the spokes 84, 86, 88 and hub 82 for controlling a steering direction of the associated vehicle.

To enhance convenience for the driver, a plurality of operational controls are mounted to the steering wheel assembly 80. Left and right turn signal indicator switches 92, 94 are provided on the first and second spokes 84, 86 respectively. The turn signal indicator switches 92, 94 are in operable communication with turn signal indicator lamps mounted on the vehicle's exterior so that depression of one of the turn signal indicator switches 92, 94 results in an external display of an intended turn indication signal.

Head lamp controls are also provided on the steering wheel assembly 80 in the form of a low beam switch 96 and a high beam switch 98 provided on the first and second spokes 84, 86 respectively. The low and high beam switches 96, 98 are in electronic communication with external headlamps of the vehicle and permit the driver to adjust headlamp intensity without having to manipulate a lever or switch provided on the steering column 18 or the instrument panel 16 of the associated vehicle.

Other operational features of the vehicle may be provided on the steering wheel assembly 80, such as a wiper switch 10 provided on the third spoke 88 for permitting the driver to control operation of external wipers on the vehicle, such as windshield wipers without requiring the driver to remove his/her hand from the steering wheel 90 and reach for a wiper lever or switch on the steering column 18 or the instrument panel 16.

Additional lighting control may be provided by a hazard signal switch 102 provided on the hub 82 for controlling a hazard signal emitted from exterior lamps of the vehicle.

Safety features may be provided in the steering wheel assembly 80 as well. For example, an air bag assembly 104 could be provided within the hub 82 for selective deployment in certain hazardous conditions as detected by the vehicle's electronic control unit.

The steering wheel assembly 80 may also include a pair of contoured webs 106, 108 for enhancing manual gripping of the wheel 90 during the steering operation of the vehicle. The webs 106, 108 extend radially inward from the wheel 90 and are provided at approximately ten o'clock and two o'clock on a dial face. The webs 106, 108 are generally padded and have a rounded exterior for enhancing gripping and traction of the driver while rotating the wheel 90. Additionally, the webs 106, 108 provide a palm heel resting support when the driver places his hands at these locations and extend his or her palms about the wheel 90.

If the driver chooses to extend his hands forward and wrap his fingers about the wheel 90, the webs 106, 108 provide a padded gripping support within the grip of the driver's fingers. Although the webs 106, 108 are illustrated aligned with and extending towards the first and second spokes 84, 86, the invention contemplates that the webs may be provided anywhere on the steering wheel assembly 80 to facilitate ergonomics and comfort to the driver.

Additionally, a flattened grip portion 110 is provided at a lower region of the steering wheel 90 for providing added clearance to the legs of the driver when seated and facing the steering wheel assembly 80.

In summary, the present invention provides various ergonomic, comfort and convenience improvements to a steering wheel assembly.

While embodiments for carrying out the invention have been described in detail, those familiar with the art to which this invention relates will recognize various alternative designs and embodiments for practicing the invention as defined by the following claims.

What is claimed:

1. A steering wheel assembly for an automotive vehicle comprising:
a hub operably connected to a steering column of the vehicle for controlling a steering direction of the vehicle;
at least one spoke extending radially outward from the hub;
a wheel mounted to the at least one spoke, the wheel having a central cavity and an outward radial thickness sized to be gripped by a passenger so that manual rotation of the wheel imparts rotation to the spoke and hub to control the steering direction of the vehicle; and
at least one contoured web extending radially inward from the wheel adjacent to an intersection of the at least one spoke and the wheel for providing ergonomic manual gripping of the wheel proximate to the at least one spoke.

2. The steering wheel assembly of claim 1 wherein the at least one spoke further comprises at least two spokes oriented generally collinear, collectively bisecting the wheel.

3. The steering wheel assembly of claim 1 wherein the at least one web engages the at least one spoke.

4. The steering wheel assembly of claim 1 wherein the at least one web has a decline relative to the wheel in an inward radial direction.

5. The steering wheel assembly of claim 1 wherein the at least one spoke further comprises a pair of spokes each extending laterally outward, wherein the at least one web is provided beneath the pair of spokes in an orientation of the steering wheel assembly corresponding to a straight direction of the vehicle.

6. The steering wheel assembly of claim 1 further comprising a cruise control switch provided on the hub or the at least one spoke in operable communication with a control unit of the vehicle.

7. The steering wheel assembly of claim 1 further comprising an audio device control switch provided on the hub or the at least one spoke in operable communication with an audio device of the vehicle.

8. The steering wheel assembly of claim 1 wherein the at least one web is molded integrally with a grip portion of the wheel.

9. The steering wheel assembly of claim 1 wherein the at least one web is molded integrally with a distal end of the at least one spoke.

10. The steering wheel assembly of claim 1 wherein the at least one web is molded integrally with a grip portion of the wheel, and with a distal end of the at least one spoke.

11. The steering wheel assembly of claim 1 wherein a surface of the wheel that faces away from the steering column lies in a plane and the at least one web has a contoured surface that is oriented between the plane and the steering column.

12. The steering wheel assembly of claim 1 wherein a surface of the wheel that faces away from the steering column lies in a plane and the at least one spoke is oriented between the plane and the steering column.

13. A steering wheel assembly for an automotive vehicle comprising:
a hub operably connected to a steering column of the vehicle for controlling a steering direction of the vehicle, the hub having at least one spoke extending radially outward from the hub;
a wheel mounted to the at least one spoke, the wheel having a central cavity and an outward radial thickness sized to be gripped by a passenger so that manual rotation of the wheel imparts rotation to the spoke and hub to control the steering direction of the vehicle;
a turn signal indicator switch provided on the hub in operable communication with turn signal indicators of the vehicle so that the passenger may control the turn signal indication from the steering wheel assembly;
a headlight intensity switch provided on the hub in operable communication with headlights of the vehicle so that the passenger may control the intensity of the headlights from the steering wheel assembly;
a hazard signal switch provided on the hub in operable communication with the turn signal indicators of the vehicle so that the passenger may control the hazard signal indication from the steering wheel assembly; and
a wiper switch provided on the hub in operable communication with a wiper assembly of the vehicle so that the passenger may control a wiping operation from the steering wheel assembly.

14. The steering wheel assembly of claim 13 further comprising an airbag assembly housed within the hub.

15. The steering wheel assembly of claim 13 further comprising at least one contoured web extending radially inward from the wheel for enhancing manual gripping of the wheel.

16. The steering wheel assembly of claim 13 wherein the at last one spoke further comprises a pair of generally collinear spokes extending laterally outward from the hub to the wheel and a third spoke extending from the hub to the wheel generally perpendicular to the pair of spokes.

17. The steering wheel assembly of claim 16 wherein the wiper switch is provided on the third spoke.

18. The steering wheel assembly of claim 13 wherein the hub further comprises a pair of diametrically opposed spokes.

19. The steering wheel assembly of claim 18 further comprising a pair of spaced apart webs, each extending radially inward from the wheel towards one of the spokes for enhancing manual gripping of the wheel opposed from the spokes.

20. A steering wheel assembly for an automotive vehicle comprising:
a hub operably connected to a steering column of the vehicle for controlling a steering direction of the vehicle;
a cross member extending radially outward from opposed sides of the hub;
a wheel mounted to the cross member at spaced apart distal ends of the cross member so that the hub is oriented generally coaxial with the hub, the wheel having a central cavity and an outward radial thickness sized to be gripped by a passenger so that manual rotation of the wheel imparts rotation to the spoke and hub to control the steering direction of the vehicle; and
a pair of webs, each extending radially inward from the wheel and engaging the cross member at an included angle provided between a lower portion of the wheel and an underside of the corresponding distal end of the cross member, each web having a decline relative to the wheel in an inward radial direction for providing support to a palm of a hand of a passenger resulting in ergonomic manual gripping of the wheel proximate to the cross member.
